(19) United States
(12) Patent Application Publication
(10) Pub. No.: US 2015/0305099 A1
(43) Pub. Date: Oct. 22, 2015

(54) Apparatus and Method for Monitoring LED Efficiency

(71) Applicants: The Secretary of Business Innovation & Skills of Her Majesty's Britannic Government, London (GB); University of Surrey, Surrey (GB)

(72) Inventors: Simon Richard Geoffrey Hall, London (GB); Andrew D. Prins, Surrey (GB); Benjamin G. Crutchley, Surrey (GB); Darren Lock, Surrey (GB); Stephen J. Sweeney, Surrey (GB)

(73) Assignees: The Secretary of State for Buisiness Innovations & Skills of Her Majesty's Britannic Governmemt, London (GB); University of Surey, Surrey (GB)

(21) Appl. No.: 14/397,930

(22) PCT Filed: Apr. 29, 2013
(86) PCT No.: PCT/GB2013/051090

§ 371 Date: Oct. 30, 2014

(30) Foreign Application Priority Data
Apr. 30, 2012 (GB) 1207503.2

(51) Int. Cl. H05B 33/08

(52) U.S. Cl. CPC H05B 33/089; H05B 33/0842

(57) ABSTRACT

A method of measuring the efficiency of an LED (10) includes illuminating the LED with light and measuring a response of the LED (10) to the absorption of light in order to measure the quantum efficiency of the LED (10). The spectrum of the light at least partially overlaps the absorption spectrum of the LED. An LED assembly (40) includes first (42) and second (44) LEDs, and a driver (43). An absorption spectrum of the first LED at least partially overlaps an emission spectrum of the second LED. The driver includes a monitor(45) for monitoring a response of the first LED to the absorption of light emitted by the second LED; a current supply (47) for supplying current to the first LED;and a switch (49) for switching between (a) operating the first LED in an absorbing mode and the second LED in an emitting mode, and (b) operating the first LED in an emitting mode.

The present application relates to a method and apparatus for monitoring the efficiency of an LED for example in an LED lighting assembly.

Since the first InGaN based high-brightness blue light emitting diode (LED) became commercially available, there has been rapid development in the field of nitride semiconductors. The development of visible light emitting diodes has been driven by a need to replace inefficient light sources that account for a fifth of the electrical energy used worldwide and also to replace Hg-containing compact fluorescent lamps (CFLs).

Using Light-Emitting Diodes (LEDs) for ambient lighting is a promising and relatively new field, offering lower electrical power consumption and preferable spectral output to other low-energy lighting alternatives, such as compact fluorescents. With ever-increasing environmental and legislative pressure to reduce carbon emissions, LEDs offer a viable but as yet unperfected aid in achieving these targets.

LEDs are inherently monochromatic; the energy (and hence colour) of photons produced corresponds to the energy between the conduction and valence bands of the semiconducting material used. There are two main approaches to producing white light from these devices, which are being explored as alternatives to incandescent bulbs and fluorescent lighting. The first is to combine light from several (at least three) LEDs, which produces light that is perceived as white by the human eye. The second is to use the LED light to stimulate a phosphor—an optically active element substituted into a host, such as a garnet. Blue Gallium Nitride (GaN) LEDs are examples of the type of devices used in phosphor-converted white LEDs.

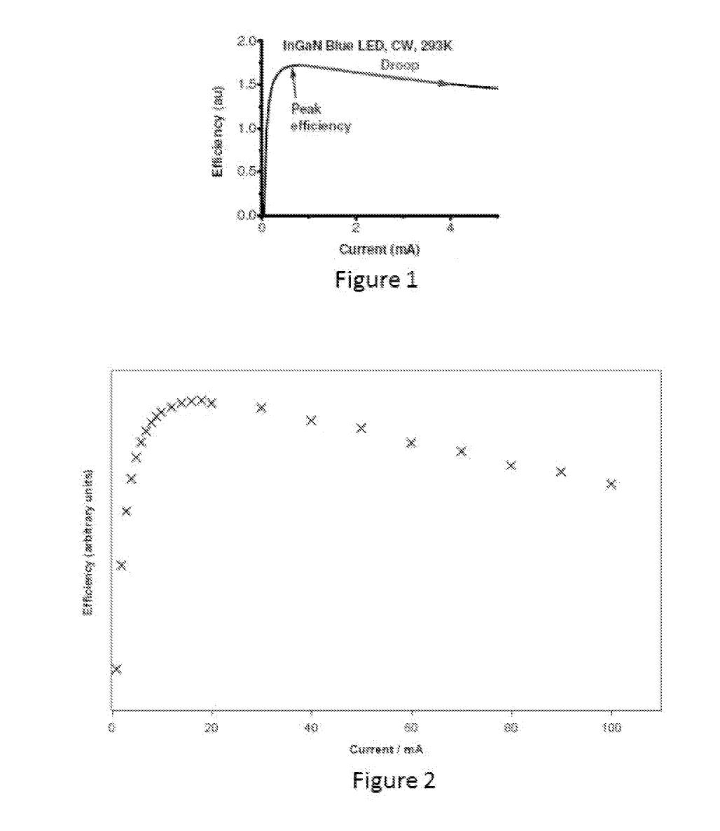

A major issue affecting InGaN-based emitters and in fact most LEDs is an effect called efficiency droop, which is where the efficiency (n=Power/Current) of the LEDs peaks at low junction temperature where the light output is relatively low and decreases with further temperature increase. This effect can be seen from the graphs shown in FIGS. 1 and 2. This reduction in efficiency is a problem as the LEDs are required to work at high power. It can reduce “wall-plug” efficiency by 50%.

“On the temperature dependence of electron leakage from the active region of GaInN/GaN light-emitting diodes” by David S. Meyaard et al., Appl. Phys. Lett. 99, 041112 (2011), states:

“Reduction in the light-output power in GaN-based light-emitting diodes (LEDs) with increasing temperature is a well-known phenomenon. In this work, temperature dependent external-quantum-efficiency versus current curves are measured, and the mechanisms of recombination are discussed. Shockley-Read-Hall recombination increases with temperature and is found to greatly reduce the light output at low current densities. However, this fails to explain the drop in light-output power at high current densities. At typical current density (35 A/cm²), as temperature increases, our results are consistent with increased Shockley-Read-Hall recombination and increased electron leakage from the active region. Both of these effects contribute to the reduction in light-output power in GaInN/GaN LEDs at high temperatures.”

In addition, as the device heats up due to the driving current or raised ambient temperature, the spectrum of emitted light also shifts, leading to a change in the colour properties of the LED.

Various methods are reported in the literature for measuring the junction temperature of LEDs. One of the simplest and most widely used techniques is the Forward-Voltage Method. This technique utilises the linear relationship between driving voltage and junction temperature. In order to measure the temperature of the diode under a constant current, a calibration must first be performed at the operating current of interest. The device is driven by a pulse generator with a low duty cycle to ensure it does not heat up due to phonon release or Joule heating. The voltage required to achieve the chosen current is measured as a function of temperature, which is normally regulated by a hot plate or oven. Once the linear calibration equation is determined, the device is run at constant current and the measured forward voltage is related back to a junction temperature.

However, the theoretical derivation of the Forward-Voltage Method is rather convoluted and draws on several assumptions, which may not be valid. The derivation starts with the assumption that the Shockley equation of ideal current-voltage-characteristics is valid and also relies on the Varshni Formula to describe bandgap variation with temperature. This model is purely empirical and is not valid at all temperatures. Of particular worry is that it is only valid below 300K for InN and AlN semiconductors. Even when the formula is valid, the derivation of the Forward-Voltage Method does not predict a perfectly linear relationship between forward-voltage and temperature.

In addition, standard current verses voltage (VI) techniques use expensive equipment that takes no account of the difference between radiative and non-radiative recombination variation of resistivity with temperature and variation of capacitance and inductance with temperature for pulsed measurement.

Capacitance, inductance, and resistance effects can mask the true junction characteristics.

Methods that use light from an LED to measure the junction temperature are somewhat more informative, as they directly probe the band structure of the device and the physical significance of the trends is easier to explain. One optical method measures the peak wavelength of the LED emission spectrum, which is shown to have a linear relationship to temperature in the high current regime. The calibration procedure is similar to that for the Forward-Voltage Method, in that pulsed voltages are used to avoid self-heating. The current should also be held constant as this has an effect on the peak wavelength.

It has also been found that the ratio of energies emitted by phosphorescence to luminescence (White to Blue, W/B) of phosphor-converted white LEDs has a linear relationship to junction temperature. However, this technique cannot be employed without a phosphor and recalibration may be necessary to take into account phosphor degradation. The linear relationship observed is purely empirical and will not necessarily hold for all systems and over a large temperature range.

Another study has found that the junction temperature can be calculated by studying the high-energy wing of the LED emission spectrum. Here, the intensity follows an almost purely exponential form due to the dominance of the Boltzmann distribution term in the theoretical expression for intensity. In theory, fitting the high-energy side of the emission peak to this function provides a measurement of the junction temperature. However, it has been observed that the system deviates from this ideal behaviour and the measurement can only provide an upper bound on the junction temperature.

In addition, some methods provide a thermocouple or Pt resistance device to measure how hot the heatsink is but these do not measure the junction temperature properly, as there are multiple weak thermal links in the way, for example between the thermocouple and heat sink, the solder used in the connections and the semiconductor substrate to the electrical connection.

Further problems occur with LEDs which provide a colour mixed light output. FIG. 13 shows an example of a tri-colour LED 5 mm package that provides a colour mixed output. A major problem with a colour mixing solution is that if the output of one of the constituent LEDs changes the spectral content of the overall illumination (usually white) can change dramatically.

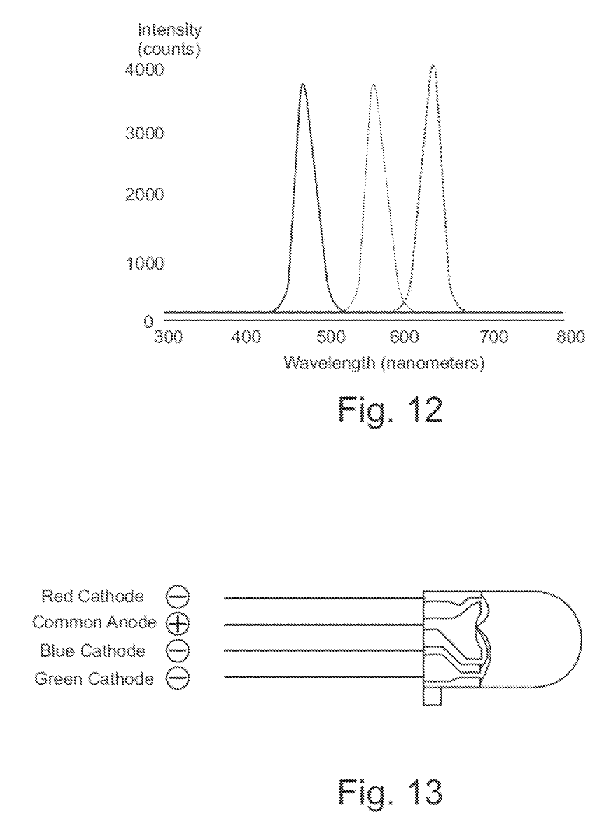

The emission power, peak wavelength, and spectral width of inorganic LEDs vary with temperature, a major difference from conventional lighting sources. LED emission powers decrease exponentially with temperature; low-gap red LEDs are particularly sensitive to ambient temperature. As a result, the chromaticity point, correlated colour temperature, CRI, and efficiency of LED-based light sources drift as the ambient temperature of the device increases. An example of the change in chromaticity point with junction temperature is shown in FIG. 12 for a trichromatic LED-based light source (FIG. 13); the chromaticity changes by about 0.02 units, thereby exceeding the 0.01-unit limit that is considered the maximum tolerable change by the lighting industry. Furthermore, the CRI changes from 84 to 72. In contrast, white sources that use phosphor, particularly UV-pumped phosphor sources, have great colour stability and do not suffer from the strong change in chromaticity and colour rendering. This is because the intra-rare-earth atomic transitions occurring in phosphors do not depend on temperature.

According to an aspect of the invention, there is provided a method of measuring the efficiency of an LED, including: illuminating the LED with light the spectrum of which at least partially overlaps the absorption spectrum of the LED; and measuring a response of the LED to the absorption of light in order to measure the quantum efficiency of the semiconductor junction of the LED.

The term “efficiency” and “quantum efficiency” are used interchangeably.

It has been found that measuring a response of an LED to the absorption of light can provide a good indication of the quantum efficiency of the LED.

In preferred embodiments, measurement of the quantum efficiency of an LED can be used with a feedback loop to keep the LED in an efficient operating regime.

In some embodiments, the response of the LED is a temperature-dependent response and the method can be used to measure the semiconductor junction temperature of the LED. However, in general, the efficiency droop of LEDs discussed above is not only dependent on temperature. Embodiments of the present invention can provide advantages by enabling a response of the LED to be measured which provides an indication of the efficiency of the semiconductor junction without requiring detailed knowledge of the physics of what factors affect the efficiency.

According to an aspect of the invention, there is provided a method of measuring a semiconductor junction temperature of an LED, including: illuminating the LED with light the spectrum of which at least partially overlaps the absorption spectrum of the LED; and measuring a temperature-dependent response of the LED to the absorption of light in order to measure the temperature of the semiconductor junction of the LED.

In some embodiments, the response of the LED includes the photocurrent or the photovoltage across the LED.

In some embodiments, illuminating the LED includes illuminating the LED with light near the absorption edge of the LED.

In some embodiments, the LED has an emitting mode and an absorbing mode, the method including operating the LED in the emitting mode and switching to operating the LED in the absorbing mode before measuring the photocurrent or the photovoltage across the LED.

In some embodiments, the LED has an emitting mode and an absorbing mode, the method including operating a driver to supply current to the LED in the emitting mode in dependence upon the response of the LED in the absorbing mode.

In some embodiments, the driver is configured with a target range of responses for the LED corresponding to a target range of efficiencies for the LED; the method including operating the driver to control the current supply to the LED in the emitting mode to maintain the response of the LED within the target range of responses or to adjust the response of the LED in the direction of the target range of responses.

In some embodiments, the target range of efficiencies for the LED includes or is the range that represents the most efficient operating regime for the LED.

In some embodiments, illuminating the LED with light includes operating a second LED in an emitting mode, wherein the emission spectrum of the second LED at least partially overlaps the absorption spectrum of the first LED.

In some embodiments, the second LED has an absorbing mode, and the method includes operating a driver to switch between (a) operating the first LED in the absorbing mode and the second LED in the emitting mode, and (b) operating the first LED in the emitting mode and the second LED in the absorbing mode.

In some embodiments, the method includes operating the driver to switch between (a) and (b) at predetermined intervals of time, at random intervals of time, or in response to manual intervention.

In some embodiments, the response of the first LED is a temperature-dependent response and/or the target range of efficiencies corresponds to a target range of temperatures.

In some embodiments, the driver is configured with a target range of responses for the LED corresponding to a target range of temperatures for the LED; the method including operating the driver to control the current supply to the LED in the emitting mode to maintain the response of the LED within the target range of responses or to adjust the response of the LED in the direction of the target range of responses. The target range of temperatures may include or be the range that represents the most efficient operating regime for the LED.

According to an aspect of the invention, there is provided an LED assembly including a plurality of LEDs, including: a first LED and a second LED, wherein the first LED has an emitting mode and an absorbing mode and the second LED has at least an emitting mode, wherein an absorption spectrum of the first LED at least partially overlaps an emission spectrum of the second LED; and a driver; the driver including: a monitor for monitoring a response of the first LED in the absorbing mode to the absorption of light emitted by the second LED; a current supply for supplying current to the first LED in the emitting mode; and a switch for switching between (a) operating the first LED in the absorbing mode and the second LED in the emitting mode, and (b) operating the first LED in the emitting mode.

In some embodiments, the driver is further configured to control the current supply to the first LED in the emitting mode in dependence upon the response of the first LED in the absorbing mode.

In some embodiments, the driver is configured with a target range of responses for the first LED corresponding to a target range of efficiencies for the first LED; wherein the driver is configured to control the current supply to the first LED in the emitting mode to maintain the response of the first LED within the target range of responses or to adjust the response of the first LED in the direction of the target range of responses.

In some embodiments, the target range of efficiencies for the first LED includes or is the range that represents the most efficient operating regime for the first LED.

In some embodiments, the driver is configured with a target range of responses for the first LED corresponding to a target range of temperatures for the first LED; and the driver is configured to control the current supply to the first LED in the emitting mode to maintain the response of the first LED with the target range of responses or to adjust the response of the first LED in the direction of the target range of responses. The target range of temperatures may be or include the range of temperatures that represents the most efficient operating regime for the first LED.

In some embodiments, the second LED has an absorbing mode, and the switch is operable to switch between (a) operating the first LED in the absorbing mode and the second LED in the emitting mode, and (b) operating the first LED in the emitting mode and the second LED in the absorbing mode.

In some embodiments, the switch is configured to switch between (a) and (b) at predetermined intervals of time, at random intervals of time, or in response to manual intervention.

In some embodiments, the response of the first LED in the absorbing mode is a photocurrent or a photovoltage, resulting from absorption of light.

In some embodiments,the response of the first LED in the absorbing mode is a temperature-dependent response and/or the target range of responses for the first LED corresponds to a target range of temperatures for the first LED.

In some embodiments, the LED assembly includes a plurality of first LEDs and at least one second LED.

In some embodiments, the LED assembly includes a plurality of second LEDs; wherein for each of the plurality of first LEDs, there is a corresponding second LED, and wherein the switch is configured to switch the LEDs between the emitting and absorbing modes, so that when the first LED is in its emitting mode the second LED is in its absorbing mode and vice versa.

In some embodiments, each second LED has an operational configuration corresponding to its corresponding first LED.

In some embodiments, the LEDs of the plurality of LEDs are all the same colour.

According to an aspect of the invention, there is provided a method of controlling the colour mix of output light from an LED assembly including a plurality of LEDs, wherein the LED assembly includes a first LED of a first colour and a second LED of a second colour; the method including:

illuminating an LED with light emitted from the first LED, wherein the absorption spectrum of the illuminated LED at least partially overlaps the emission spectrum of the first LED;

determining a response of the illuminated LED to the absorption of light and thereby obtaining an indication of the light output of the first LED; and

controlling a current supply to at least one LED of the plurality of LEDs in dependence upon the indication of the light output of the first LED whereby to maintain a desired colour mix of output light from the LED assembly.

In some embodiments, controlling a current supply to at least one LED includes controlling a current supply to the second LED and/or to a third LED of a third colour.

In some embodiments, the method includes:

illuminating an LED with light emitted from the second LED, wherein the absorption spectrum of the second illuminated LED at least partially overlaps the emission spectrum of the second LED; and determining a response of the second illuminated LED to the absorption of light and thereby obtaining an indication of the light output of the second LED;

wherein controlling a current supply to at least one LED of the plurality of LEDs includes controlling a current supply to the first and second LEDs in dependence upon the indication of the light output of the first and second LEDs whereby to maintain a desired colour mix of output light from the LED assembly.

In some embodiments, the LED assembly includes a third LED of a third colour; the method including:

illuminating an LED with light emitted from the third LED, wherein the absorption spectrum of the third illuminated LED at least partially overlaps the emission spectrum of the third LED; and determining a response of the third illuminated LED to the absorption of light and thereby obtaining an indication of the light output of the third LED;

wherein controlling a current supply to at least one LED of the plurality of LEDs includes controlling a current supply to the first, second and third LEDs in dependence upon the indication of the light output of the first, second and third LEDs whereby to maintain a desired colour mix of output light from the LED assembly.

In some embodiments, the first, second and third colours are respectively red, green and blue.

In some embodiments, the method includes maintaining the illuminated LED or illuminated LEDs at a predetermined temperature, whereby to prevent their response to the absorption of light changing as a result of temperature fluctuations.

In some embodiments, maintaining the illuminated LED or illuminated LEDs at a predetermined temperature includes preventing its or their operation in an emitting mode.

According to an aspect of the invention, there is provided an LED assembly including a plurality of LEDs, including:
a first LED of a first colour and a second LED of a second colour; and
a driver, the driver including:

a monitor for monitoring a response of an LED of the plurality of LEDs, the absorption spectrum of which at least partially overlaps the emission spectrum of the first LED, to the absorption of light emitted by the first LED and thereby obtaining an indication of the light output of the first LED; and

a current supply for supplying current to at least one LED of the plurality of LEDs; wherein the driver is configured to control the current supply to supply current to the at least one LED of the plurality of LEDs in dependence upon the indication of the light output of the first LED whereby to maintain a desired colour mix of output light from the LED assembly.

In some embodiments, the at least one LED includes the second LED and/or a third LED of a third colour.

In some embodiments, the monitor is configured to monitor a response of an LED of the plurality of LEDs, the absorption spectrum of which at least partially overlaps the emission spectrum of the second LED, to the absorption of light emitted by the second LED and thereby obtain an indication of the light output of the second LED;

wherein the current supply is configured to supply current to the first and second LEDs; and

wherein the driver is configured to control the current supply to supply current to the first and second LEDs in dependence upon the indication of the light output of the first and second LEDs whereby to maintain a desired colour mix of output light from the LED assembly.

In some embodiments, the LED assembly includes a third LED of a third colour; wherein the monitor is configured to monitor a response of an LED of the plurality of LEDs, the absorption spectrum of which at least partially overlaps the emission spectrum of the third LED, to the absorption of light emitted by the third LED and thereby obtain an indication of the light output of the third LED;

wherein the current supply is configured to supply current to the first, second and third LEDs; and wherein the driver is configured to control the current supply to supply current to the first, second and third LEDs in dependence upon the indication of the light output of the first, second and third LEDs whereby to maintain a desired colour mix of output light from the LED assembly.

In some embodiments, the first, second and third colours are respectively red, green and blue.

In some embodiments, the monitored LED or the monitored LEDs are prevented from operating in an emitting mode, whereby to maintain the monitored LED or monitored LEDs at a predetermined temperature to prevent their response to the absorption of light changing as a result of temperature fluctuations.

According to an aspect of the invention, there is provided a driver for an LED assembly such as the LED assemblies described above.

The present invention provides a method and apparatus to measure the efficiency of the LED semiconductor junction directly, and produce a low cost feedback mechanism to control the current supplied to the LED to keep it in the most efficient operating regime.

It also allows measurement of the bandgap of LEDs to allow testing of methods for reduction of efficiency degradation in GaN LEDs as used for solid-state lighting.

The invention provides for measurement of the semiconductor junction directly and a low cost feedback mechanism to control the current supplied to the LED to keep it in the most efficient operating regime, therefore avoiding reduced efficiency via the “droop-effect”. The ability to maintain LED efficiency at its peak not only reduces energy consumption but also extends LED lifetime. The technology uses existing components coupled with a new circuit design, allowing for cheap and easy integration into production lines. It allows for extended LED lifetime, reduced energy consumption via efficiency improvement using a feedback current control loop.

Potential applications for the LED Efficiency Measurement technology include:
Illumination
Automotive Applications
Consumer Electronics & General Indication
Sign Applications
Signal Application
Mobile Applications
Low cost light or temperature sensing

Preferred embodiments of the invention are described below, by way of example only, with reference to the accompanying drawings, in which:

FIGS. 1 and 2 show graphs of efficiency against current for LEDs, showing the droop effect;

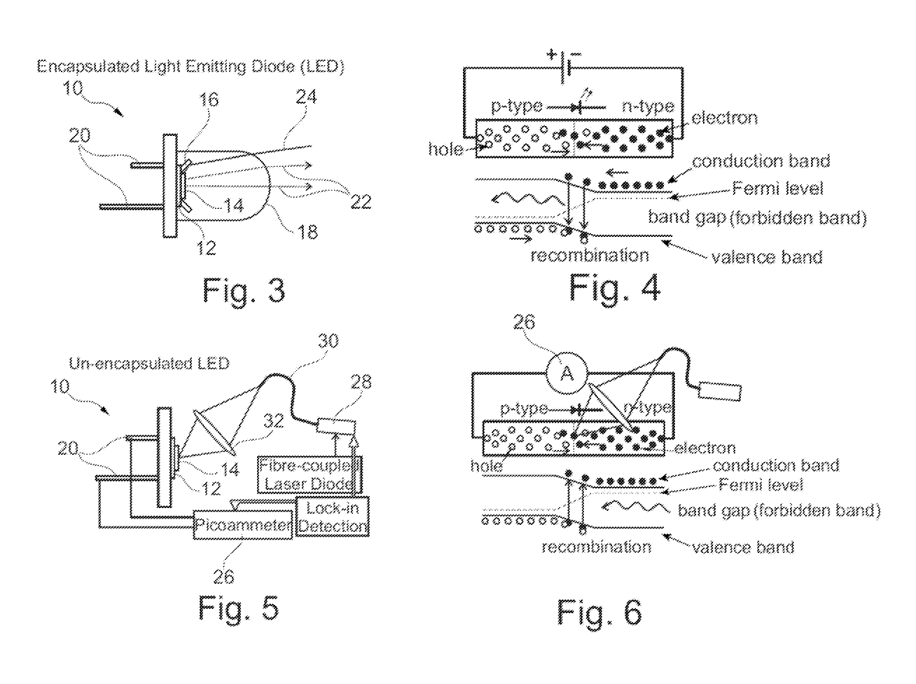

FIG. 3 is a schematic drawing of a conventional encapsulated LED;

FIG. 4 is a schematic drawing showing the physics behind the operation of the LED of FIG. 3;

FIG. 5 is a schematic drawing of an arrangement for measuring the efficiency of an LED according to an embodiment of the invention;

FIG. 6 is a schematic drawing showing the physics behind the operation of the arrangement of FIG. 5;

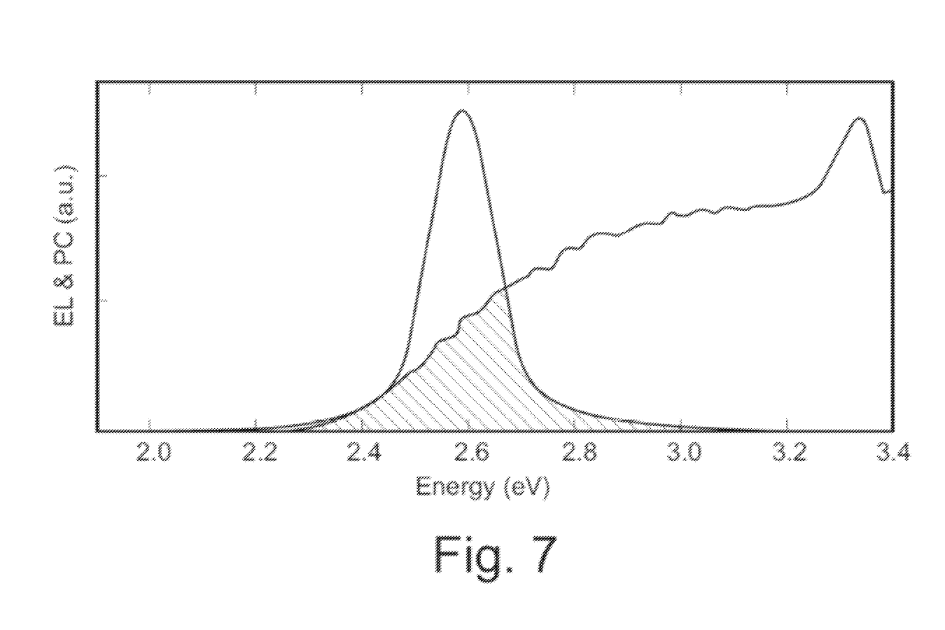

FIG. 7 is a graph showing the overlap of the emission spectrum of a blue LED with the absorption spectrum of a green LED;

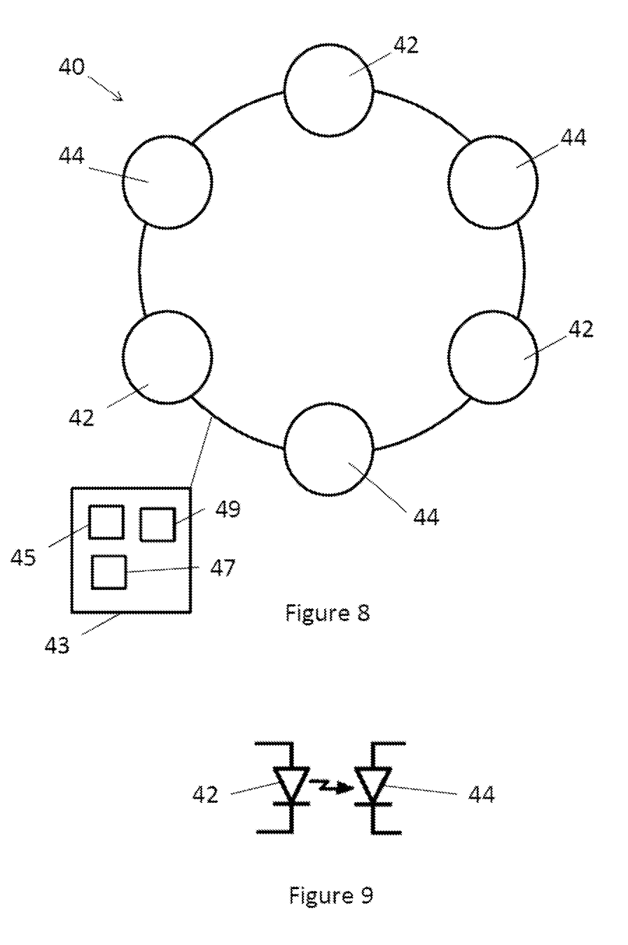

FIG. 8 is a schematic depiction of an LED assembly according to an embodiment of the invention;

FIG. 9 is a schematic depiction of one pair of LEDs of the embodiment of FIG. 8;

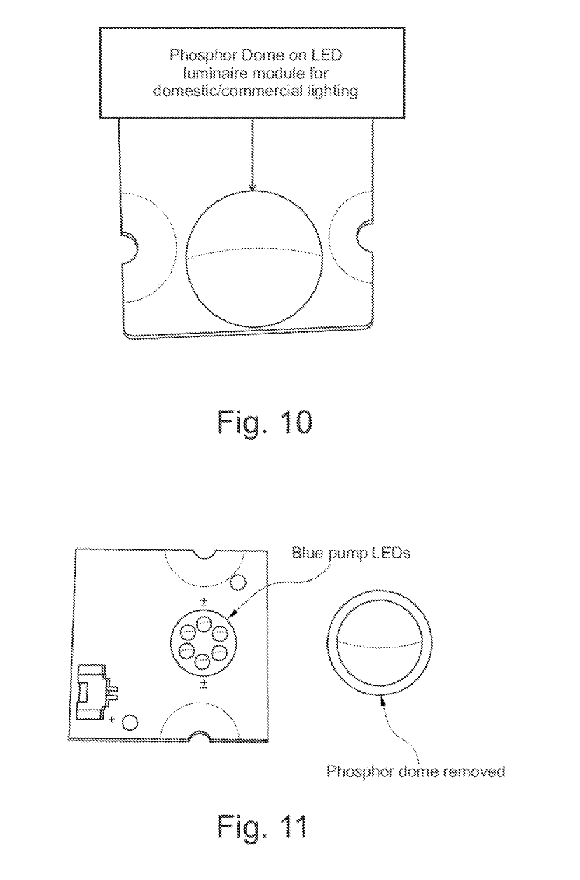

FIGS. 10 and 11 depict an LED assembly according to an embodiment of the invention;

FIG. 12 shows a graph of intensity against wavelength for a trichromatic LED-based light source;

FIG. 13 is a schematic depiction of a trichromatic LED-based light source;

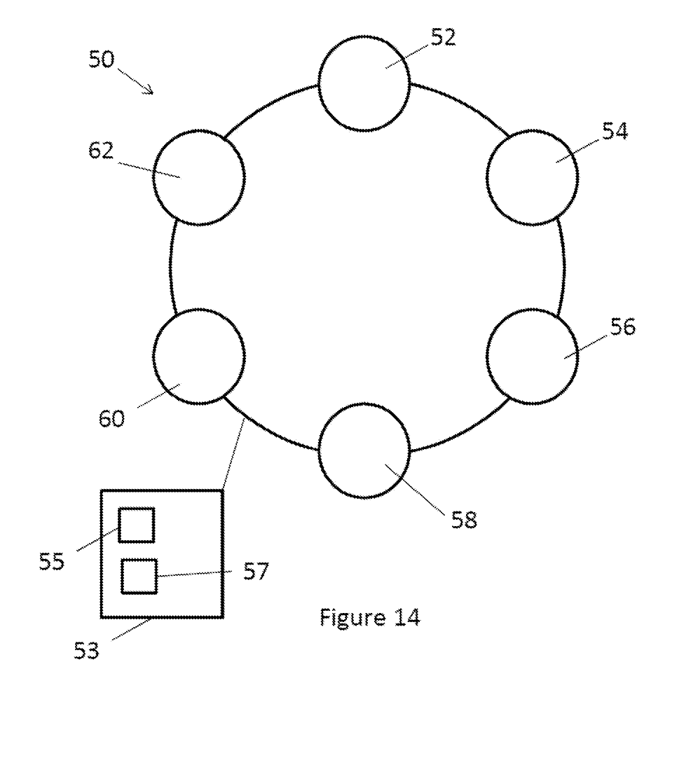

FIG. 14 is a schematic depiction of an LED assembly according to another embodiment of the invention;

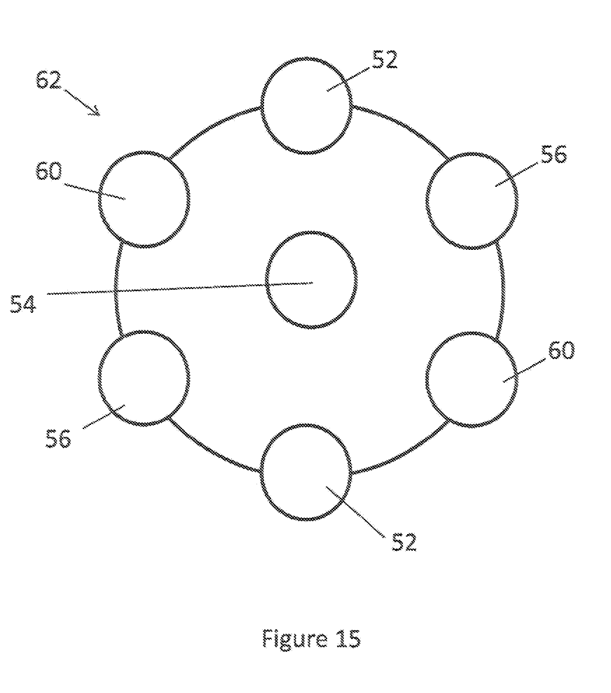

FIG. 15 is a schematic depiction of an LED assembly according to another embodiment of the invention; and

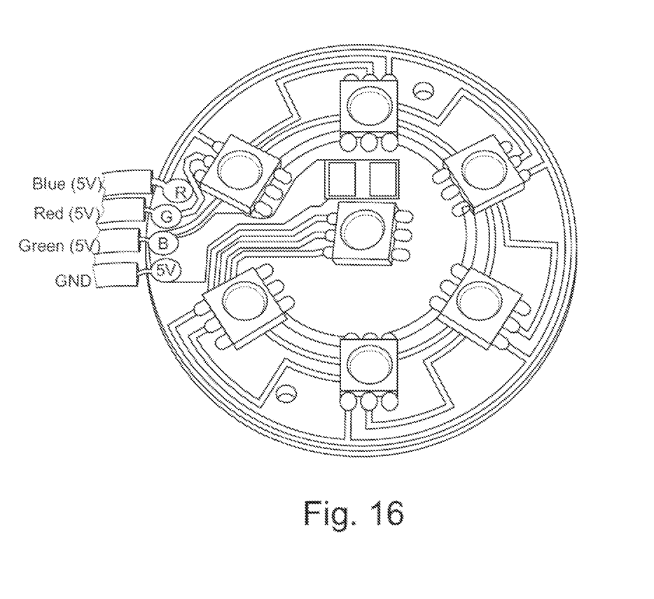

FIG. 16 is a photograph of an LED assembly including the features of the embodiment of FIG. 15.

FIG. 3 shows a conventional encapsulated light emitting diode (LED).

LED 10 includes a substrate 12 on which is provided a chip 14. Around the edges of chip 14 is provided a reflector 16 which is arranged to redirect laterally emitted rays of light to be more closely aligned with a principal direction of emission from the LED. To restrict the divergence of rays in the LED shown in FIG. 3, a dome lens 18 is provided.

The LED 10 is caused to emit light by applying a voltage across terminals 20, which causes the chip 14 to emit light. Some rays are direct rays 22 which are emitted from a forward face of the chip 14. Laterally emitted rays are reflected by the reflector 16 and can be considered reflected rays 24.

A schematic depiction of the physics of operation of the LED 10 is shown in FIG. 4. As can be seen from FIG. 4, upon application of a voltage across the LED semiconductor, electrons in the n-type semiconductor material, and holes in the p-type semiconductor material are drawn towards the p-n junction, where they undergo recombination, causing the emission of photons of light. Since this process is well known in the art, a more detailed description is not included here.

As explained above, it can be difficult to determine the efficiency or junction temperature of an LED, in many cases because there are multiple weak thermal links between a thermocouple for measuring the temperature of the junction.

FIG. 5 shows a schematic arrangement for measuring the efficiency of an LED according to an embodiment of the invention.

In the arrangement illustrated in in FIG. 5, the LED is unencapsulated, meaning that the dome lens 18 has been omitted. However, the other features of the LED 10 are the same as for the arrangement of FIG. 3. The reflector 16 has not been depicted in FIG. 5.

In FIG. 5, rather than applying a voltage to the terminals 20, the terminals 20 are connected to a monitor 26 such as a picoammeter. The picoammeter is configured to detect a current flowing between the terminals 20, through the LED 10. However, the monitor 26 does not need to be a picoammeter, it can be a voltmeter, in which case it measures the voltage between the terminals 20.

In addition, a light source 28, such as a laser diode, is provided, the output of which is directed by an optical fibre 30 towards the chip 14. An optical element 32 such as a lens can be used to focus the light onto the chip 14.

When it is desired to measure the efficiency of the semiconductor junction of the LED 10, the light source 28 is operated to cause it to emit light which is directed by the optical fibre 30 onto the chip 14. FIG. 6 shows a schematic depiction of the physics of the efficiency measurement. As shown in FIG. 6, the arrival of light within the absorption spectrum of the LED 10 can cause electrons and holes to separate in the p-n junction by absorption of photons of the incoming light. This separation creates a potential difference which causes a small current to flow between the terminals 20, which is then measured by the picoam meter 26. The current measured by the picoam meter 26 provides an indication of the quantum efficiency of the junction but can also be converted to a temperature measurement of the semiconductor junction by using a predetermined correlation of junction temperature to photocurrent.

In the case where the monitor 26 is a voltmeter, the potential difference can be measured and converted to a temperature by using a predetermined correlation of junction temperature to photovoltage.

In other words, this technique is based on the principle that LEDs can be used as photodiodes, absorbing light and creating a current in a circuit or a voltage across the LED terminals. The response of the LED as a photodiode depends on the junction temperature of the LED. Indeed, if an LED is switched off from the source current and illuminated with light from an adjacent LED or other light source the voltage output will be proportional to the junction temperature. The fraction of incident light that can be absorbed and hence the voltage induced, depends on the size of the bandgap, which decreases as the junction temperature is increased.

Therefore, if one measures the photocurrent or photovoltage during operation, the instantaneous junction temperature can be found.

In order to measure a photovoltage, the LED must be open-circuit. If the LED is short-circuited or held at negative bias, the photocurrent flows and can be measured. The distinction between these two quantities, the open-circuit voltage and short-circuit current, is significant and measuring them requires different electrical circuits. Both short-circuit current and open-circuit voltage depend on the size of the LED bandgap, so both can be used for this technique.

The correlation between photovoltage/current and temperature can be predicted qualitatively with knowledge of the absorption spectrum of the LED 10 under test and the emission spectrum of the source 28 used to illuminate it. The absorption and emission spectra of a device are quite different, varying in peak wavelength and shape. The difference between a material's absorption and emission spectra is known as the Stokes' Shift and it has been observed in Gallium Nitride LEDs with a peak shift of the order of an electronvolt. This leads to the counterintuitive result that a green LED absorbs at a higher energy than the blue LED emits. This may not only be down to the fundamental differences in the processes of absorption and emission, but also the part of the device where each occurs.

It is not necessary for the illuminating light source 28 to be a laser diode. It can be any light source, for example an LED. However, for very accurate measurement, a monochromatic source such as a laser diode is used to illuminate the LED. The voltage/current induced will depend on the overlap between the illuminating and absorbing devices' spectra. How this overlap varies with the decreasing bandgap of the absorbing device will depend on the relative position and shape of the two peaks. FIG. 7 demonstrates this principle more clearly by showing an example using a blue LED to illuminate a green LED. The blue LED has the narrow emission peak and was measured with electroluminescence. The green LED has the broad absorption peak and was measured using photocurrent. The overlap (shown in grey) depicts the magnitude of the induced photovoltage across the green LED when illuminated by the blue LED. In this case, when the green heats up and its band gap narrows, the absorption peak shifts to the left and the overlap increases.

One way in which a correlation between temperature and the temperature dependent response of an LED can be determined is to place the LED 10 into an oven. The chip 14 can then be illuminated by the light source 28 and the photocurrent or photovoltage measured at a range of predetermined temperatures of the oven to provide a correlation curve.

The above described method is able to provide an accurate way of measuring the quantum efficiency or junction temperature of an LED, because the LED semiconductor junction is measured directly.

In the above described method, it is not necessary to have an optical fibre 30 or an optical element 32, as long as illuminating light, the spectrum of which at least partially overlaps the absorption spectrum of the LED 10, illuminates the chip 14 of the LED 10.

As explained above, an inherent problem in many LEDs is the “droop” effect in which the efficiency peaks at a low current/temperature. As current increases the junction gets hotter. However the theoretical “droop” mechanisms described earlier are not just temperature related so for example Auger is related to number of carriers. Proposed mechanisms change in significance with current eg between low and high current levels

In actuality the methodology does not rely on a knowledge of the exact “droop” mechanism as this is still a research topic but allows the LED to be treated as a “black box” and that all that is required is the relationship between current in and light out for the current value used to power the LED. A control loop can then optimise that current to ensure that the highest efficiency is achieved

The method described above can therefore be used to advantage in an LED assembly to maintain the LEDs at the most efficient part of their efficiency curve.

An embodiment of such an LED assembly is described below.

FIG. 8 depicts an LED assembly 40 including a plurality of LEDs. In the embodiment depicted, there are six LEDs, however, as is clear from the description below, any number of LEDs can be included as long as there is at least a first LED 42 and a second LED 44.

In the embodiment depicted in FIG. 8, there are three first LEDs 42, and three second LEDs 44. The LEDs are arranged in pairs of adjacent LEDs, each pair including a first LED and a second LED. The pairs of LEDs are arranged such that light emitted by the first LED 42 of the pair will illuminate the second LED 44 of the pair, and vice versa. One such pair of LEDs is shown schematically in FIG. 9, in which a first LED 42 is shown illuminating a second LED 44.

Each LED has an emitting mode and an absorbing mode. In the emitting mode, the LED emits light according to its emission spectrum in response to a supplied current. In the absorbing mode, the LED absorbs light according to its absorption spectrum and generates a corresponding photocurrent and/or photovoltage.

The LED assembly 40 includes a driver 43.

The driver includes a monitor 45 for monitoring a response of each of the LEDs in the absorbing mode to the absorption of light. As explained in respect of the method for measuring the efficiency or junction temperature of the LED, the monitor can be an ammeter or a voltmeter.

The driver also includes a current supply 47 for supplying current to each of the LEDs in their respective emitting mode.

The driver also includes a switch 49 for switching each pair of LEDs between (a) the driver operating the first LED 42 in the absorbing mode and the second LED 44 in the emitting mode, and (b) the driver operating the first LED 42 in the emitting mode and the second LED 44 in the absorbing mode.

The driver is configured with a target range of responses from the monitor for each LED. These correspond to a target range of efficiencies for each LED, which correspond to the most efficient operating regime for each LED. The driver is configured to obtain the response for each LED from the monitor and to compare it to the target range of responses for that LED. The driver is configured to operate a feedback loop by controlling the current supply to each LED in its emitting mode in accordance with its monitored response in the absorbing mode, with the aim of keeping the efficiency of the respective LED within the respective target range of efficiencies, or adjusting the efficiency of the respective LED as closely as possible to the respective target range of efficiencies.

The LED assembly 40 operates as follows.

The driver operates each of the first LEDs 42 in the emitting mode by causing the current supply to supply a current to first LEDs 42. The second LEDs 44 are operated in the absorbing mode. As shown in FIG. 9, for each pair of LEDs the first LED 42 emits light in accordance with its emission spectrum. This light, owing to the at least partial overlap of the emission spectrum of the first LED 42 and the absorption spectrum of the respective second LED 44 of the pair of LEDs, is absorbed by that second LED. The absorption of light by the second LED 44 causes a corresponding photocurrent or photovoltage to be generated which is detected by the monitor as a response. This response is compared by the driver to the predetermined range of responses for the second LED 44.

The switch then switches so that the driver operates the first LEDs 42 in the absorbing mode and the second LEDs 44 in the emitting mode. This includes operating the current supply to supply a current to the second LEDs 44. As explained above the current supply is controlled by the driver to supply current to the second LEDs 44 in dependence upon their respective response measured by the monitor when the second LEDs were in the absorbing mode. The current supply is controlled to maintain the second LEDs 44 within their respective target ranges of efficiencies, or to bring the efficiency of the second LEDs 44 closer to their respective target ranges of efficiencies.

In the absorbing mode, the first LED 42 of each pair generates a photocurrent or photovoltage in response to light absorbed from the corresponding second LED 44 of the pair owing to the at least partial overlap of the emission spectrum of the second LED 44 and the absorption spectrum of the first LED 42. The monitor monitors this photocurrent or photovoltage as a response.

When the first LEDs are in the emitting mode, the driver operates the current supply to control the current supply to the first LEDs 42 in dependence upon their respective response measured by the monitor in the when the first LEDs 42 were in the absorbing mode so as to maintain each of the first LEDs 42 within their respective target ranges of efficiencies, or to adjust their efficiencies to be as close as possible to their respective target ranges of efficiencies.

The switch continues to switch between (a) the driver operating the first LEDs 42 in the absorbing mode and the second LEDs 44 in the emitting mode, and (b) the driver operating the first LEDs 42 in the emitting mode and the second LEDs 44 in the absorbing mode.

The switch switches between (a) and (b) at predetermined intervals. However, the switch can switch between (a) and (b) at random intervals of time, or in response to manual intervention.

The LED assembly 40 described above is a self-monitoring assembly which can maintain each of its constituent LEDs in its most efficient operating regime. This is able to increase the efficiency of the LED assembly overall, enabling the LED assembly to provide an effective and an environmentally friendly method of lighting. In addition, where the LEDs include different colours, maintaining each of the LEDs in the most efficient operating regime is able to maintain a more consistent colour mix than some prior art assemblies.

A further advantage of the LED assembly described above is that it requires only relatively minor modifications from existing technology since existing LED assemblies already include drivers which convert AC to DC and provide some modulation of the LEDs in the assembly.

Many modifications may be made to the embodiment shown in FIG. 8 while retaining these advantages. For example, the switch described above switches each pair at the same time. However, the switching of pairs of LEDs can be staggered. Alternatively, the switching of each pair can be independent of the switching of any other pair.

In addition, in FIG. 8, the first and second LEDs are arranged in pairs in which the illumination light for monitoring a response of an LED comes from the corresponding LED of its pair. However, any arrangement could be envisaged as long as each LED to be monitored is switched between an absorbing mode and an emitting mode, and when in the absorbing mode is illuminated by light which at least partially overlaps its absorption spectrum.

It is not necessary for every LED to be monitored. It is possible to include one or more LEDs, the principal purpose of which is to illuminate other LEDs in their respective absorbing modes so that the monitored LEDs do not need to be arranged in pairs of first and second LEDs. However, such a modification is not preferred since the overall efficiency of the LED assembly is most improved when all of the LEDs are controlled to operate in their most efficient regime.

The LEDs 42, 44 can be different colours or can be all the same colour. An embodiment shown in FIGS. 10 and 11 includes only blue LEDs, but the LED assembly is covered by a phosphor dome which converts blue light to white light for lighting purposes.

The driver can be augmented with a CMOS switch which provides high isolation between current supply and current sensing circuits. More LED drivers are using Field Programmable Gate Arrays (FPGA); these will provide enough isolation to allow the current supply and current sensing operations to be switched with sufficient isolation

As described above, the quantum efficiency of an LED can be dependent upon the semiconductor junction temperature of the LED. Accordingly, in some embodiments, the responses of the LEDs described above are temperature dependent responses and the target ranges of efficiencies are target ranges of temperatures.

Having an adaptive system for conventional blue pumped phosphor LEDs also means that the lifetime is increased as the temperature would be kept lower due to less non-radiative recombination.

As described above, a problem with LED assemblies including multiple colours is that if the output of one of the constituent LEDs changes the spectral of the assembly as a whole can change dramatically.

FIG. 14 shows an embodiment of an LED assembly 50 which is designed to maintain a consistent colour mix of output light.

The LED assembly 50 includes a first red LED 52, a second red LED 54, a first green LED 56, a second green LED 58, a first blue LED 60, and a second blue

LED 62. The LED assembly 50 also includes a driver 53. The driver includes a monitor 55 for monitoring a response of the second red LED 54, the second green LED 58 and the second blue LED 62, to the absorption of light. The monitor can be as described in connection with the above embodiments.

The driver also includes a current supply 57 for supplying current to the first red LED 52, the first green LED 56, and the first blue LED 60.

This precise arrangement is not essential. For example, the colours do not need to be red, green and blue, but could be any colours of the designer's choice. In addition, the second red, green and blue LEDs 54, 58, 62 do not need to be red, green, and blue LEDs, but need to be LEDs, the absorption spectrum of which at least partially overlaps the emission spectrum of respectively the red first LED 52, the first green LED 56, and the first blue LED 60.

The driver is configured to operate the current supply to the first red LED 52, the first green LED 56, and the first blue LED 60 in dependence upon respectively the monitored response of the second red LED 54, the second green LED 58, and the second blue LED 62 so as to ensure that the first red LED 52, the first green LED 56, and the first blue LED 60 are maintaining the desired relative output to provide the desired colour mix of output light.

In operation, the driver operates the current supply to supply current to the first red LED 52 to cause it to emit light in accordance with its emission spectrum. Owing to the at least partial overlap of the absorption spectrum of the second red LED 54 with the emission spectrum of the first red LED 52, some of this light is absorbed by the second red LED 54. This causes the second red LED 54 to generate a photocurrent or a photovoltage, which is detected by the monitor as a response of the second red LED 54. The second green and blue LEDs operate in an analogous manner with respect to respectively the first green and blue LEDs so that the monitor detects a response from each of the second red LED 54, the second green LED 58, and the second blue LED 62. The driver compares these responses with each other and compares this comparison with a desired relative output of the LED assembly. The driver then controls the current supply to adjust if necessary the current supplied to the first red LED 52, the first green LED 56, and/or the first blue LED 60 in order to provide the desired relative output of red, green and blue.

As explained above, the response of an LED to absorbed light is dependent upon the temperature of that LED. For this reason, the second red LED 54, the second green LED 58, and the second blue LED 62 are not operated in an emitting mode but are maintained at an ambient or predetermined temperature. Therefore, the responses of these LEDs are indicative of the light output of respectively the first red LED 52, the first green LED 56, and the first blue LED 60. In this way, the

LED assembly 50 can monitor the colour mix of its own output in an economical way by using redundant LEDs as photodiodes. It is able to adjust the relative output of the colours in order to maintain a desired colour mix, thereby increasing the useful lifetime of the LED assembly 50.

Nevertheless, in a modification of this embodiment, it is possible to monitor the responses of the first red LED 52, the first green LED 56, and the first blue LED 60, and for the current supply to be operable for supplying current to the second red LED 54, the second green LED 58 and the second blue LED 62, wherein the absorption spectra of the first red, green and blue LEDs at least partially overlap, respectively, the emission spectra of the second red, green and blue LEDs. In this modification, the driver includes a switch for switching between (a) operating the first red, green and blue LEDs in an emitting mode and the second red, green and blue LEDs in an absorbing mode, and (b) operating the second red, green and blue LEDs in an emitting mode and the first red, green and blue LEDs in an absorbing mode. In each case, the driver is configured to operate the current supply to the LEDs in the emitting mode in dependence upon the monitored response of the LED of the corresponding colour that is in the absorbing mode. This is performed in an analogous manner to the method described above for supplying the current to the first red, green and blue LEDs in dependence upon the response of the second red, green and blue LEDs. This can ensure that the LEDs are maintaining the desired relative output to provide the desired colour mix of output light. The switch can switch between (a) and (b) at predetermined intervals, at random intervals of time, or in response to manual intervention.

However, it is not necessary to monitor each of the colours. FIG. 15 schematically depicts an alternative embodiment including two first red LEDs 52, two first green LEDs 56, and two first blue LEDs 60. In addition, the LED assembly 62 includes a single second red LED 54. The driver is not shown in FIG. 15. The second red LED 54 operates in conjunction with the two first red LEDs 52 so as to monitor the red output of the LED assembly 62 as described in respect of FIG. 14. However, in the embodiment of FIG. 15, since only the red output is being monitored, the current supplied to the first green LEDs 56 and the first blue LEDs 60 is controlled in dependence only upon the monitored red output in order to keep the green and blue output consistent with the red output. The current supplied to the first red LEDs 52 may be controlled in dependence on the monitored second red LED 54 in addition to or alternatively to controlling the current supply to the first green LEDs 56 on the first blue LEDs 60. In addition, to avoid temperature induced changes the second red LED 54 can be kept at ambient temperature and used as a detector with restricted spectral sensitivity.

While this embodiment may not provide the same precision in terms of the resulting colour mix, it benefits from the fact that only one colour need be monitored and there are therefore fewer redundant LEDs. This can reduce the cost and size of the assembly 62.

FIG. 16 is a photograph of an LED assembly including the features of the embodiment depicted schematically in FIG. 15.

As explained above, the number of LEDs is not important. There could be as many LEDs of each colour as required for the lighting solution being designed.

All optional and preferred features and modifications of the described embodiments and dependent claims are usable in all aspects of the invention taught herein. Furthermore, the individual features of the dependent claims, as well as all optional and preferred features and modifications of the described embodiments are combinable and interchangeable with one another.

The disclosures in UK patent application number 1207503.2, from which this application claims priority, and in the abstract accompanying this application are incorporated herein by reference.

1. A method of measuring the efficiency of an LED, including:
illuminating the LED with light the spectrum of which at least partially overlaps the absorption spectrum of the LED; and
measuring a response of the LED to the absorption of light in order to measure the quantum efficiency of the semiconductor junction of the LED.

2. A method according to claim 1, wherein the response of the LED includes the photocurrent or the photovoltage across the LED.

3. A method according to claim 1, wherein illuminating the LED includes illuminating the LED with light near the absorption edge of the LED.

4. A method according to claim 1, wherein the LED has an emitting mode and an absorbing mode, the method including operating the LED in the emitting mode and switching to operating the LED in the absorbing mode before measuring the photocurrent or the photovoltage across the LED.

5. A method according to claim 1, wherein the LED has an emitting mode and an absorbing mode, the method including operating a driver to supply current to the LED in the emitting mode in dependence upon the response of the LED in the absorbing mode.

6. A method according to claim 5, wherein the driver is configured with a target range of responses for the LED corresponding to a target range of efficiencies for the LED; the method including operating the driver to control the current supply to the LED in the emitting mode to maintain the response of the LED within the target range of responses or to adjust the response of the LED in the direction of the target range of responses,
wherein the target range of efficiencies for the LED preferably includes or is the range that represents the most efficient operating regime for the LED.

7. (canceled)

8. A method according to claim 1, wherein illuminating the LED with light includes operating a second LED in an emitting mode, wherein the emission spectrum of the second LED at least partially overlaps the absorption spectrum of the first LED.

9. A method according to claim 8, wherein the second LED has an absorbing mode, and the method includes operating a driver to switch between (a) operating the first LED in the absorbing mode and the second LED in the emitting mode, and (b) operating the first LED in the emitting mode and the second LED in the absorbing mode; the method preferably including operating the driver to switch between (a) and (b) at predetermined intervals of time, at random intervals of time, or in response to manual intervention.

10. (canceled)

11. A method according to claim 1, wherein the response of the first LED is a temperature-dependent response and/or wherein the target range of efficiencies corresponds to a target range of temperatures.

12. An LED assembly including a plurality of LEDs, including:
a first LED and a second LED, wherein the first LED has an emitting mode and an absorbing mode and the second LED has at least an emitting mode, wherein an absorption spectrum of the first LED at least partially overlaps an emission spectrum of the second LED; and
a driver; the driver including:
a monitor for monitoring a response of the first LED in the absorbing mode to the absorption of light emitted by the second LED;
a current supply for supplying current to the first LED in the emitting mode; and
a switch for switching between (a) operating the first LED in the absorbing mode and the second LED in the emitting mode, and (b) operating the first LED in the emitting mode.

13. An LED assembly according to claim 12, wherein the driver is further configured to control the current supply to the first LED in the emitting mode in dependence upon the response of the first LED in the absorbing mode.

14. An LED assembly according to claim 13, wherein the driver is configured with a target range of responses for the first LED corresponding to a target range of efficiencies for the first LED; wherein the driver is configured to control the current supply to the first LED in the emitting mode to maintain the response of the first LED within the target range of responses or to adjust the response of the first LED in the direction of the target range of responses;
wherein the target range of efficiencies for the first LED preferably includes or is the range that represents the most efficient operating regime for the first LED.

15. (canceled)

16. A LED assembly according to claim 12, wherein the second LED has an absorbing mode, and the switch is operable to switch between (a) operating the first LED in the absorbing mode and the second LED in the emitting mode, and (b) operating the first LED in the emitting mode and the second LED in the absorbing mode.

17. An LED assembly according to claim 12, wherein the switch is configured to switch between (a) and (b) at predetermined intervals of time, at random intervals of time, or in response to manual intervention.

18. An LED assembly according to claim 12, wherein the response of the first LED in the absorbing mode is a photocurrent or a photovoltage, resulting from absorption of light.

19. An LED assembly according to claim 12, wherein the response of the first LED in the absorbing mode is a temperature-dependent response and/or the target range of responses for the first LED corresponds to a target range of temperatures for the first LED.

20. An LED assembly according to claim 12, including a plurality of first LEDs and at least one second LED.

21. An LED assembly according to claim 20, including a plurality of second LEDs; wherein for each of the plurality of first LEDs, there is a corresponding second LED, and wherein the switch is configured to switch the LEDs between the emitting and absorbing modes, so that when the first LED is in its emitting mode the second LED is in its absorbing mode and vice versa;
wherein each second LED preferably has an operational configuration corresponding to its corresponding first LED.

22. (canceled)

23. An LED assembly according to claim 12, wherein the LEDs of the plurality of LEDs are all the same colour.

24. A driver for an LED assembly according to claim 12.
